(19) United States
(12) Patent Application Publication
(10) Pub. No.: US 2005/0276381 A1
(43) Pub. Date: Dec. 15, 2005

(54) Rotary target locking ring assembly

(75) Inventors: George M. Wityak, Albuquerque, NM (US); Bruce W. Webb, Albuquerque, NM (US)

Correspondence Address: PEACOCK MYERS, P.C., 201 THIRD STREET, N.W., SUITE 1340, ALBUQUERQUE, NM, 87102, US

(73) Assignee: Academy Corporation, Albuquerque, NM (US)

(21) Appl. No.: 11/118,514

(22) Filed: Apr. 29, 2005

Related U.S. Application Data
(63) Continuation-in-part of application No. 10/614,308, filed on Jul. 2, 2003.
(60) Provisional application No. 60/566,714, filed on Apr. 29, 2004.

(51) Int. Cl. H01J 35/10

(52) U.S. Cl. 378/132

(57) ABSTRACT

The present invention comprises a locking ring assembly for a rotary target used in a physical deposition process of the type that comprises at least one rotary target segment mechanically disposed on a backing tube. The locking ring assembly comprises an inner ring and an outer ring, both comprising cooperative threading. The inner ring comprises two or more separable segments.

### CROSS-REFERENCE TO RELATED APPLICATIONS

This application is a continuation-in-part application of U.S. patent application Ser. No. 10/614,308, entitled “Rotary Target”, filed on Jul. 2, 2003, and the specification and claims thereof are incorporated herein by reference. This application also claims priority to U.S. Provisional Patent Application Ser. No. 60/566,714, entitled “Locking Mechanism Ring for Rotary Target”, filed on Apr. 29, 2004, and the specification of that application is incorporated herein by reference. This application also is related to PCT Application No. PCT/US03/21211 entitled “Rotary Target” filed Jul. 2, 2022, U.S. Provisional Patent Application Ser. No. 60/442,080, entitled “Rotary Target and Clamping Mechanism Assembly”, filed on Jan. 22, 2003, and U.S. Provisional Patent Application Ser. No. 60/393,547, entitled “Rotary Targets for Deposition of Metal Films,” filed on Jul. 2, 2003, and the specifications and claims thereof are incorporated herein by reference.

### BACKGROUND OF THE INVENTION

1. Field of the Invention (Technical Field)

The present invention relates to a locking ring for use with a locking system for backing tubes and rotary targets used in conjunction with rotary sputtering target systems.

2. Background Art

Backing tubes are required in many rotary sputtering target applications. The dimensions of target tubes or backing tube are determined based on the commercially available sizes of seamless extrusions. The use of commercially available seamless pipe extrusions helps minimize costs and provides a customer more choices in vendors. However, several collateral factors can increase the costs of using such tubes.

For example, the backing tubes typically comprise machined special ends to provide a water-to-vacuum seal. Such fabrication is expensive. If reclaiming or reworking a tube is desired, it must be shipped to a facility for such work. The incorporation of certain properties into tube designs limits vendor selection and may limit the types of materials that can be utilized.

The tubes are often of such length that shipping costs are disproportionate to the shipping weight. Also, critical surfaces can be damaged in transit or in handling during the reworking of the tubes. There is also a high capital cost resulting from the length of time a tube is not in operation.

Another significant impact on the cost of using such tubes is the desire for additional film coating materials to apply to rotary configuration designs. Many of the additional materials are not commercially available in extruded form and are better applied using traditional forming techniques such as deep drawing. Those techniques and the use of plasma spraying and cast tube products require that a tube be returned to a vendor for rework.

To address the problems and costs associated with shipping tubes for rework, the inventions cross-referenced and/or described herein comprise a method of producing sleeves that provides flexibility in material selection, wall thickness, and grain structure. Of more significance, the target tubes are built at the end user's facility. The method comprises fabricating target sleeve tubes that are slipped over, or threaded onto, a backing tube. The apparatus and methods of the cross-referenced applications and of the present invention provide for locking the sleeves onto the backing tubes.

The inventions cross-referenced herein and described herein have a pronounced impact on the types of materials that can be utilized. High cost materials such as silver, gold, platinum, and palladium and their alloys can now be realistically considered in tube form. The use of unique refractory alloys such as those of zirconium and niobium as well as high density silicon is viable. Hard, abrasive materials such as nickel-chromium and tungsten and the magnetic alloys are also suitable materials. The assembled cathodes are preferably optimized by constructing a “dog bone” increased wall thickness in high erosion areas or using low cost materials for the ends that are typically off the substrate.

Because the target sleeves are readily disassembled at an end user's site, most materials can be removed and directly recycled. Unlike cast-on or sprayed tubes, the separation and segregation method is simple and low cost. The spent targets are returned to the target vendor or to a third party for reclamation.

### BRIEF SUMMARY OF THE INVENTION

The present invention comprises a locking ring assembly for a rotary deposition target, the assembly comprising a backing tube, an inner ring comprising two or more sections, each section comprising at least one serrated end and a threaded outer surface, and an outer ring comprising an inner surface cooperatively threaded with the threaded outer surface of the inner ring. The outer ring preferably comprises a hinge. The inner ring may comprise a hinge.

The backing tube preferably comprises a circumferential groove and an inner surface of each of the sections comprises a projection disposable in the groove. A first section mates with a second section, forming at least a part of a ring.

The first serrations of a serrated end of the first section preferably mirror second serrations of a serrated end of the second section. The serrated end preferably comprises serrations which comprise angled faces. The angled faces are preferably disposed at an angle to a line drawn radially through a thickness of said section.

The present invention also comprises a method for assembling a rotary deposition target, the method comprising providing at least one rotary target segment, disposing the at least one rotary target segment on a backing tube, securing at least two threaded inner locking ring sections together by mating mirrored serrations on ends of the sections which are to be mated, thereby forming an inner locking ring around an end of the backing tube, and screwing a threaded outer locking ring to the inner locking ring. The method preferably further comprises disposing a projection on an inner surface of the inner locking ring sections in a groove circumferentially disposed on an outside surface of the backing tube. The serrations preferably comprise angled faces.

The securing step preferably comprises preventing the relative movement in two dimensions of the at least two inner locking ring sections. The method further preferably comprises removing the at least one rotary target segment from the backing tube after the at least one rotary target segment is spent. Removal may be accomplished by the user. The method may further comprise disposing at least one new rotary target segment on the backing tube.

A primary object of the present invention is to effectively and efficiently secure rotary target sleeves onto backing tubes.

A primary advantage of the present invention is that a locking ring assembly can be securely and immovably disposed on a backing tube without having to slide the assembly onto the tube.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into, and form a part of, the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side view of a target sleeve and backing tube assembly utilizing the preferred embodiment of the present invention.

FIG. 2 is a top perspective view of the preferred embodiment of the locking ring of the present invention showing two separate sections;

FIG. 3 is a top perspective view showing the embodiment of FIG. 1 with two joined sections;

FIG. 4 is a side perspective view of the outside of a rotary target sleeve disposed on a backing tube and the locking ring mechanism of the present invention disposed on the backing tube; and

FIG. 5 shows a serrated end of a section of the inner ring illustrating a preferred orientation of the machined serrations of the preferred embodiment.

### DETAILED DESCRIPTION OF THE INVENTION

The present invention comprises a locking ring assembly to lock segmented rotary target sleeves onto a backing tube. The locking ring assembly comprises an inner ring and an outer ring. The invention preferably contributes to a low profile clamping system that provides the ability to remove and replace the target sleeve segments at any site and by the user. The present invention provides for the use of greater wall thickness and shape enhancement that is either not commercially available or otherwise too costly to produce.

As used throughout the specification and claims, “serrated” and “serrations” mean any non-flat surface geometry which comprises sufficient topological structure to prevent relative movement in at least one dimension of two joined objects having mirrored serrations. Serrations may comprise projections having triangular, rectangular, or any other (preferably geometric) shape. A serrated surface may comprise one or more hemispherical projections, or the surface itself may be hemispherically or triangularly shaped. The serrations may be regularly or irregularly spaced and/or shaped. The serrations are preferably oriented along more than one axis.

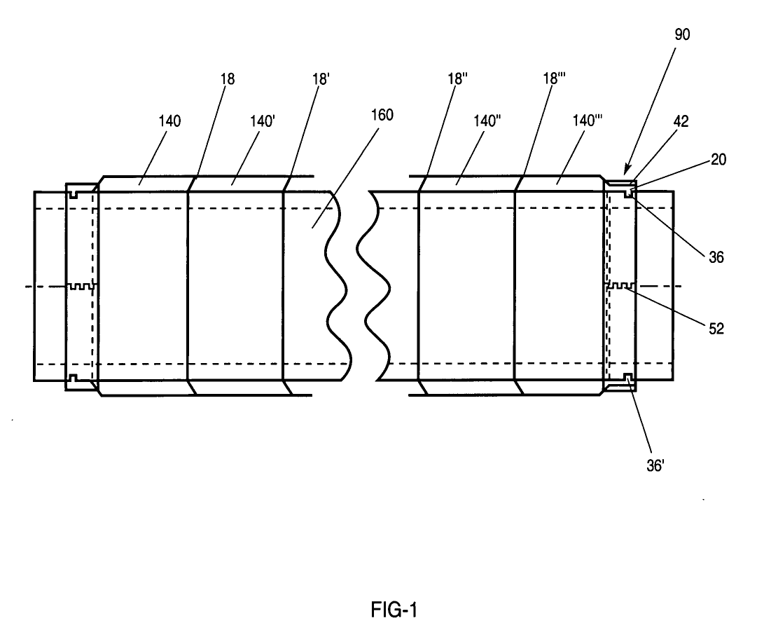

The locking ring assembly of the present invention is attachable to a rotary target and backing tube assembly used in physical deposition processing. Specifically, as shown in FIG. 1, locking ring assembly 90 is used to secure one or more rotary target segments or sleeves 140, 140′, 140″, 140′″, etc. to backing tube 160. Joints, or seams, 18, 18′, 18″, 18′″, etc. located between each individual segment may comprise a square cut, a tapered cut, a lock and key cut, or any other cut or joint, depending on the application.

In the preferred embodiment of the present invention, segments 140, 140′, 140″, 140′″ are secured in place by locking ring assembly 90 disposed between each segment or at the end of backing tube 160. Locking ring assembly 90 preferably comprises inner ring 20 and outer ring 42. Inner ring 20 is preferably threaded on its outer surface/face, and outer ring 42 is cooperatively threaded on its inner surface/face. Outer ring 42 preferably comprises a hinge 52. Outer ring 42 preferably opens opposite hinge 52. Outer ring 42 and inner ring 20 preferably interconnect as outer ring 42 is secured over inner ring 20 and threaded onto inner ring 20. Although the figures depict circular rings, it is understood that the rings may comprise any geometry, although a circular or semi-circular geometry is preferred. Thus, sections 22, 24 described herein are preferably arcuate.

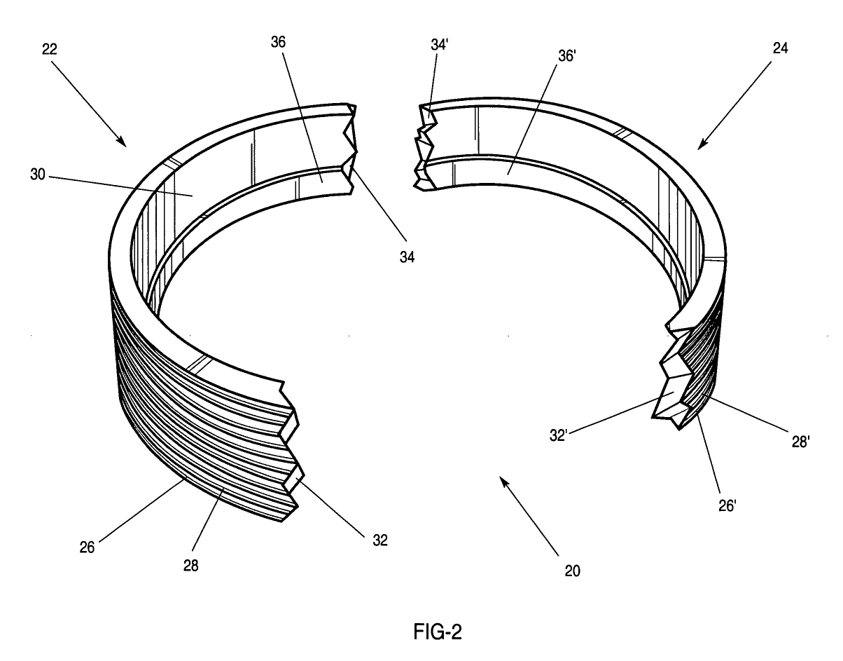

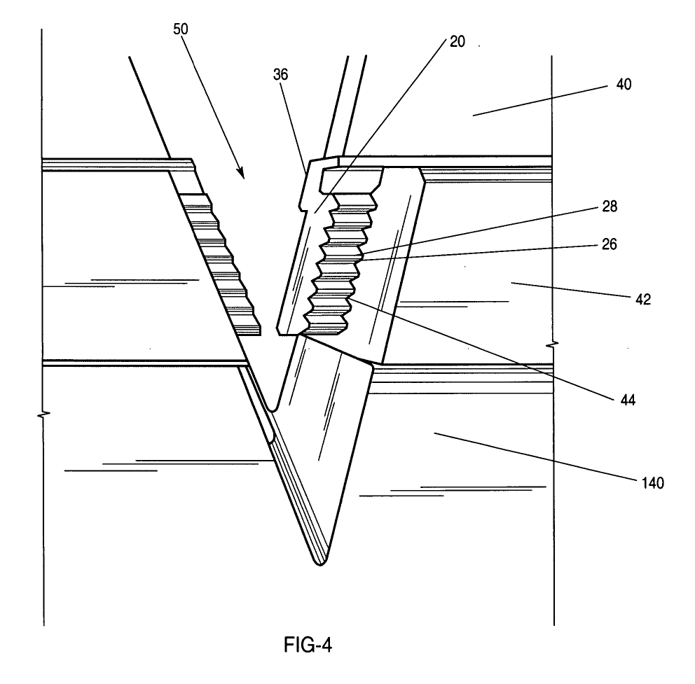

Turning now to FIG. 2, the preferred embodiment of inner ring 20 is shown which comprises two separable sections 22, 24, however, any number of sections may be utilized. Each section 22, 24 is preferably of equal dimensions. Sections 22, 24 preferably comprise contiguous machined threads 26, 26′ on exterior faces 28, 28′ of inner ring sections 22, 24. Inner walls (faces) 30, 30′ of inner ring sections 22, 24 are preferably of a split level/stepped design with stepped-up, thicker projections 36, 36′ disposable within a groove (not shown) in backing tube 40 (as shown in FIG. 4). The groove is preferably a circumferential groove. In the preferred embodiment of the present invention, sections 22, 24 are not hinged, although they may be hinged in other embodiments.

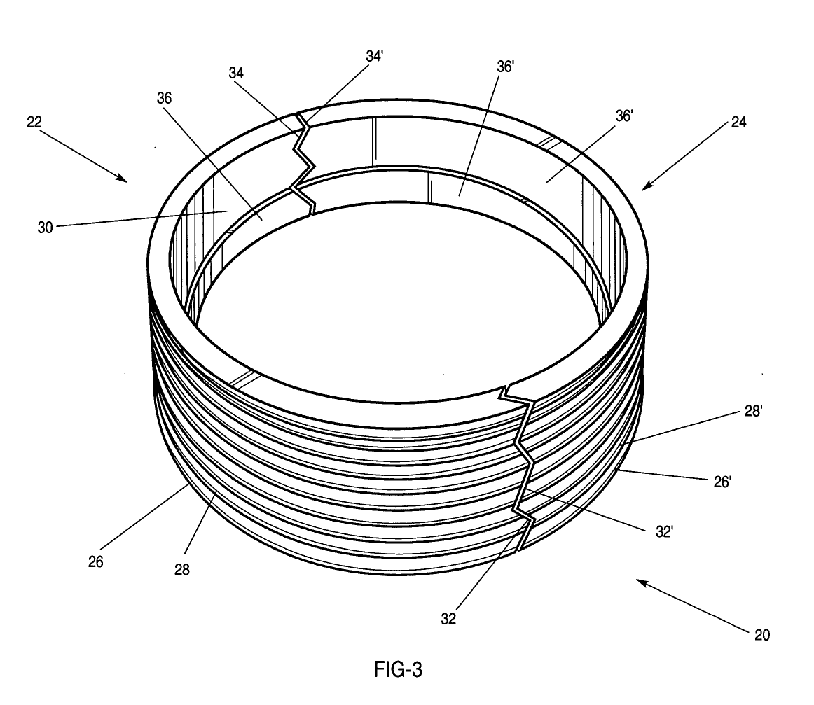

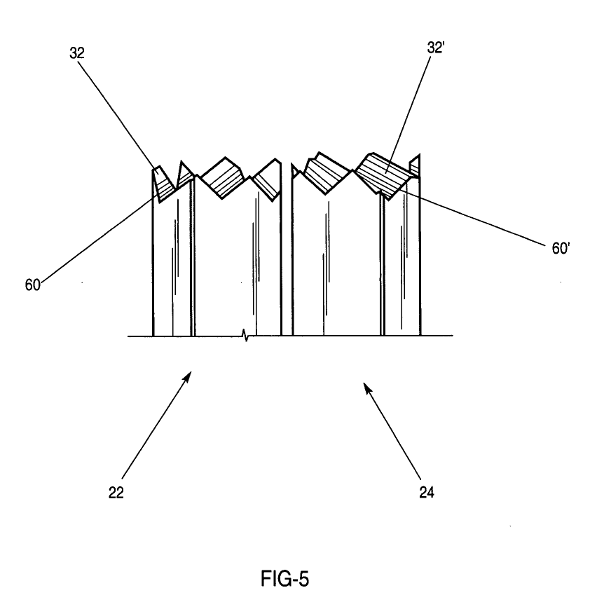

Inner ring sections 22, 24 preferably comprise ends 32, 32′, 34, 34′ with serrations 60, 60′ (i.e., serrated faces) (as detailed in FIG. 5). The serrations of each end mirror the serrations of the end of the other section to which it will mate when sections 22, 24 are brought together to connect as shown in FIG. 3. The serrations may be of any type and dimensions that provide for positional stability of sections 22, 24 when end 32 connects to end 32′ and end 34 connects to end 34′ as shown in FIG. 3. The serrations are preferably machined.

FIG. 4 shows how inner ring 20 operates as it is disposed onto backing tube 40. To facilitate viewing, notch 50 is cut out to expose the various components for viewing. Backing tube 40 comprises a groove (not shown) along its outer wall to receive thicker projections 36 of inner wall 30. Thus disposed, inner ring 20 is held into position as outer ring 42 is threaded onto inner ring 20. Outer ring 42 comprises machined threads 44 on its inner surface cooperatively threaded to machined threads 26 on exterior face 28 of inner ring 20. As outer ring 42 is threaded onto inner ring 20, which is now longitudinally immovable due to projection 36 being disposed in the groove of the backing tube, outer ring 42 exerts a clamping pressure onto sleeve 140. Thus, any number or variety of sleeves may be disposed on backing tube 40 and pressed into a desired position by the pressure exerted by outer ring 42 as outer ring 42 threads onto inner ring 20.

Because inner ring 20 comprises inner ring sections 20, 24, inner ring 20 may be snugly disposed onto backing tube 40 without the need to slide it onto tube 40. Thus, any impediment to sliding a ring onto a tube, such as a tube's flared ends, have no effect on the ability to dispose inner ring 20 onto backing tube 40.

Inner ring 20 may comprise any material, preferably a rigid material, more preferably a metal. Although the preferred embodiment depicted in the figures shows inner ring 20 comprising two halves 22, 24, inner ring 20 may comprise any number of sections. Threads 26, 26′ may comprise any design/configuration known in the art.

Serrations 60, 60′ forming serrated ends 32, 32′ (and representative of all such serrations) preferably comprise projections as shown in FIGS. 2 and 3 and illustrated in more detail in FIG. 5, although any orientation may be utilized. FIG. 5 shows a detail of preferred serrations 60, 60′ of inner ring 20 of the present invention. Serrations 60, 60′ preferably comprise projections comprising irregular angled projection faces. Although the projection faces may be parallel to a radial line through the thickness of inner ring 20 (similar to teeth on a common gear), they preferably also form an angle to said radial line as the projections extend throughout the ring thickness, as detailed in FIG. 5. This prevents sections 22, 24 from moving radially with respect to one another after they are joined. Thus, the serrations 60, 60′ preferably prevent relative movement in two dimensions of inner ring sections 22, 24.

### EXAMPLE

An inner ring as described herein was constructed of steel. It measured approximately 5¾ inches in outer diameter, approximately 5¼ inches in inner diameter, and approximately 7/8 inch in width. It comprised two sections, each of which comprised half of the total circumference of the ring, and each section comprised an asymmetrical thread on its outer wall. Its inner wall fit into a notch running along the outside of a backing tube. The inner ring functioned successfully in securely fitting around the backing tube and allowing an outer ring to be threaded onto the inner ring so that the outer ring applied a clamping pressure to secure multiple sleeves onto the backing tube as the outer ring was threaded onto the immovable inner ring.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above, and of the corresponding application(s), are hereby incorporated by reference.

1. A locking ring assembly for a rotary deposition target, the assembly comprising:
a backing tube;
an inner ring comprising two or more sections, each section comprising at least one serrated end and a threaded outer surface; and
an outer ring comprising an inner surface cooperatively threaded with said threaded outer surface of said inner ring.

2. The locking ring assembly of claim 1 wherein said outer ring comprises a hinge.

3. The locking ring assembly of claim 1 wherein said inner ring comprises a hinge.

4. The locking ring assembly of claim 1 wherein said backing tube comprises a circumferential groove and an inner surface of each of said sections comprises a projection disposable in said groove.

5. The locking ring assembly of claim 1 wherein a first section mates with a second section, forming at least a part of a ring.

6. The locking ring assembly of claim 5 wherein first serrations of a serrated end of said first section mirror second serrations of a serrated end of said second section.

7. The locking ring assembly of claim 1 wherein said serrated end comprises serrations which comprise angled faces.

8. The locking ring assembly of claim 7 wherein said angled faces are disposed at an angle to a line drawn radially through a thickness of said section.

9. A method for assembling a rotary deposition target, the method comprising the steps of:
providing at least one rotary target segment;
disposing the at least one rotary target segment on a backing tube;
securing at least two threaded inner locking ring sections together by mating mirrored serrations on ends of the sections which are to be mated, thereby forming an inner locking ring around an end of the backing tube; and
screwing a threaded outer locking ring to the inner locking ring.

10. The method of claim 9 further comprising the step of disposing a projection on an inner surface of the inner locking ring sections in a groove circumferentially disposed on an outside surface of the backing tube.

11. The method of claim 9 wherein the serrations comprise angled faces.

12. The method of claim 9 wherein the securing step comprises preventing the relative movement in two dimensions of the at least two inner locking ring sections.

13. The method of claim 9 further comprising the step of removing the at least one rotary target segment from the backing tube after the at least one rotary target segment is spent.

14. The method of claim 13 wherein the removing step is performed by the user.

15. The method of claim 13 further comprising the step of disposing at least one new rotary target segment on the backing tube.
